(19) United States
(12) Patent Application Publication
(10) Pub. No.: US 2023/0347340 A1
(43) Pub. Date: Nov. 2, 2023

(54) Flow Cell for Integrating a Processing Unit into a Microfluidic Device and Method for Processing a Sample Fluid

(71) Applicant: Robert Bosch GmbH, Stuttgart (DE)

(72) Inventors: Daniel Sebastian Podbiel, Rutesheim (DE); Hannah Bott, Straubenhardt (DE)

(21) Appl. No.: 18/040,507

(22) PCT Filed: Jul. 27, 2021
(86) PCT No.: PCT/EP2021/070915

§ 371 Date: Feb. 3, 2023

(30) Foreign Application Priority Data
Aug. 12, 2020 (DE) 10 2020 210 219.8

(51) Int. Cl. B01L 3/00

(52) U.S. Cl. CPC B01L 3/502715; B01L 2200/027; B01L 2200/12; B01L 2300/047; B01L 2300/0877

(57) ABSTRACT

A flow cell for integrating a processing unit into a microfluidic device has a receiving unit with a depression The processing unit is/can be arranged in the depression. The flow cell also has a cover unit for covering the depression and at least one capillary gap for receiving a fluid, wherein the capillary gap is formed between an edge region of the cover unit and the receiving unit and, additionally or alternatively, between the cover unit and the processing unit.--

### PRIOR ART

The invention proceeds from a flow cell for integrating a processing unit into a microfluidic device and a method for processing a sample liquid with a flow cell according to the generic type of the independent claims. The subject matter of the present invention is also a computer program.

Microfluidic devices or systems permit decentralized analysis of patient samples by modern molecular diagnostic methods. For highly reliable and fully automated performance of microfluidic process flows and targeted manipulation of sample liquids in such systems, both a suitable design of the structures and suitable performance of the process steps are generally necessary to ensure the desired functionalities. Among other things, a suitable design of the microfluidic structures and the use of capillary effects is used, for example, by the implementation of so-called phase guides for the complete filling of the microfluidic structures.

### DISCLOSURE OF THE INVENTION

In light of this, with the approach presented herein, a flow cell for integrating a processing unit into a microfluidic device and a method for processing a sample liquid with a flow cell are presented. Furthermore, a control device using this method and finally a corresponding computer program according to the main claims are presented. By the measures listed in the dependent claims, advantageous further developments and improvements of the device specified in the independent claim are possible.

The invention presented herein creates a balance between possible impairments of the functionality of microfluidic structures by structural or chemical inhomogeneities, such as a rough surface, on a surface to be wetted with a sample liquid. Undesirable pinning of phase interfaces to such inhomogeneities is prevented or reduced, whereby fluid guidance in the microfluidic device is facilitated. The filling characteristic of the microfluidic device is also positively influenced, which advantageously affects reproducibility.

A flow cell for integrating a processing unit into a microfluidic device is presented, wherein the flow cell comprises a receiving unit with a depression, wherein the processing unit is or can be arranged in the depression. In addition, the flow cell comprises a cover unit for covering the depression and at least one capillary gap for receiving a fluid (e.g., in a capillary manner), wherein the capillary gap is formed between an edge region of the cover unit and the receiving unit and, additionally or alternatively, between the cover unit and the processing unit.

The microfluidic device may, for example, be a so-called lab-on-chip system that may be employed by various integrated components for the preparation and analysis of various sample liquids. For example, an aqueous solution, for example for performing chemical, biochemical, medical or molecular diagnostic analyses, may be used as the sample liquid. This may, for example, be a so-called PCR master mix or rITA master mix, in particular with sample material contained therein, for example of human origin, obtained from, for example, body fluids, smears, secretions, sputum, or tissue samples. The targets to be detected in the sample liquid may, for example, be of medical, clinical, therapeutic, or diagnostic relevance and may, for example, be bacteria, viruses, specific cells, such as circulating tumor cells, cell-free DNA, proteins, or other biomarkers. In order to process such a sample liquid and other fluids, a processing unit can be integrated into the flow cell presented herein and may, for example, be an aliquoting structure, for example a multi-cavity array for introducing a sample liquid, or microfluidic separation structures, for example a mesh or filter. When using, for example, a microcavity array in which individual, separate reactions are to be carried out, the filling and sealing of the microcavity array is of great importance since fluidic crosstalk between the cavities is to be prevented as much as possible. For this purpose, the processing unit is arranged in the depression of the receiving unit, wherein the depression can, for example, have dimensions of 3 x 3 x 0.1 mm³ to 30 x 30 x 3 mm³, preferably 3 x 3 x 0.3 mm³ to 10 x 10 x 1 mm³. When the receiving unit is assembled with the cover unit, for example by gluing or welding, a capillary gap is formed that is designed to receive and enclose a fluid, for example the sample liquid, by means of capillary forces. Advantageously, a phase interface may thus be created between the sample liquid in the capillary gap and another fluid, which may, for example, be directed to the processing unit for a reaction. Continuous pinning-free filling of subregions of the microfluidic device with a sample liquid is thus enabled, for example a filling in which continuous progression of at least one phase interface, adjacent to the sample liquid, through the microfluidic device is achieved. Furthermore, filling with a liquid that does not wet a surface of the microfluidic device or only wets it slightly may be achieved, with undesirable pinning of the phase interface, adjacent to the sample liquid, to inhomogeneities of the structural surface being preventable.

According to one embodiment, the cover unit may comprise a recess, wherein between the processing unit, arranged or arrangeable in the depression, and the recess, a receiving chamber for receiving the fluid may be given. For example, the receiving chamber may have a volume of 1 µl to 1 ml, preferably 3 µl to 100 µl, in particular 20 µl. Such a receiving chamber has the advantage that an introduced fluid can be easily received and evenly distributed across the processing unit. The cover unit may, for example, be transparent so that the distribution as well as the reaction occurring in the receiving chamber can be observed from outside the flow cell.

In addition, a capillary gap height may be less than a height of a central region of the receiving chamber, wherein the capillary gap height may in particular be at least no more than 10% of the height of the central region of the receiving chamber. For example, the height of the capillary gap may be 10 µm to 500 µm, in particular 100 to 150 µm. Advantageously, this may optimize the reception of fluids by means of capillary forces.

According to a further embodiment, the flow cell may comprise a further capillary gap, which may be arranged on a further edge region of the cover unit opposite the capillary gap. For example, the capillary gap and the further capillary gap may extend in the direction of flow along the receiving chamber, whereby the receiving chamber can advantageously be sealed nearly entirely laterally by a fluid and an undesirable pinning effect can be avoided. For example, by using a liquid that wets the initial structural surface well, any undesirable structural inhomogeneities present in the structural surface can be wetted or filled with the liquid so that pinning, for example, of the sample liquid, to these inhomogeneities can be prevented or significantly reduced.

According to a further embodiment, the cover unit may comprise an elevation along the edge region, wherein a capillary channel can be formed between the elevation and the edge region, wherein the capillary gap can in particular be formed between the elevation and the processing unit. For example, the elevation may extend similarly to a step or a bead in parallel to the edge region of the cover unit and thus form the capillary channel. When introducing a fluid into the receiving chamber, the fluid may, for example, be drawn directly into the capillary channel by capillary forces or may be drawn into the capillary channel by capillary forces during filling of the receiving chamber through the capillary gap formed between the elevation and the processing unit. Advantageously, by forming such an elevation, in addition to a material saving, optical marking for centering the cover unit on the receiving unit may also take place.

According to a further embodiment, the flow cell may comprise an inlet opening for introducing the fluid in a direction of flow into the receiving chamber, wherein the receiving chamber may be laterally delimited in the direction of flow by the capillary gap and the further capillary gap. For example, the flow cell may be designed to receive a fluid through the inlet opening and to dispense it again through an outlet opening arranged, for example, opposite the inlet opening. As a result of the lateral delimitation by the capillary gap and the further capillary gap, a fluid located in the receiving chamber, for example a sample liquid, can advantageously be completely displaced by a subsequently introduced fluid, wherein undesirable pinning of the phase interface, adjacent to the sample liquid, to inhomogeneities of the structural surface can be prevented. A sequential processing with several fluids can thus advantageously be enabled. This is in particular desired if it is necessary for the analysis of a sample to completely fill and re-empty a microfluidic structure at least in subregions or to completely displace a fluid from the structure.

According to a further embodiment, the capillary gap may be adjacent to the depression. For example, the capillary gap may extend along a side region of the depression, wherein direct proximity to the processing unit arranged in the depression is simultaneously given. Such an arrangement has the advantage that the spatial volume of the receiving chamber, including the capillary gap, can be kept as low as possible, whereby the use of a low amount of fluid is also enabled. Furthermore, surface-independent microfluidic processing is enabled in that the fluid enclosed in a capillary manner defines the surface properties of the structure and thus the fluidic processing.

In addition, a method for processing a sample liquid with a variant of the previously presented flow cell is presented, the method comprising a step of wetting the at least one capillary gap with the fluid, a step of enclosing a portion of the fluid in the capillary gap, and a step of introducing a sample liquid into the receiving chamber. The step of wetting the at least one capillary gap with the fluid may also be referred to as priming structures, wherein these structures are pre-wetted by the fluid to be processed or by an additional fluid. A gas, for example CO₂, or a further fluid, for example ethanol, may be used for this purpose, for example.

According to one embodiment, in the method, the sample liquid may be used as the fluid for the steps of wetting, enclosing and introducing. The use of the sample liquid to prime the microfluidic structure is particularly advantageous if the flow cell may not be wetted with additional fluids, in particular in predetermined subregions, prior to the sample analysis. Advantageously, a portion of the sample liquid may thus be enclosed in the at least one capillary gap and may thus prevent subsequent fluids from pinning to surface inhomogeneities of the receiving chamber.

According to a further embodiment, the method may additionally comprise a step of displacing at least a portion of the fluid by means of the sample liquid and, additionally or alternatively, by means of a further fluid. Advantageously, in the previously presented flow cell, this method may also be used to perform sequential process steps, in which different fluids are successively introduced into a microfluidic structure. A requirement in the sequential process management can therefore also be the complete displacement of a fluid from the receiving chamber by a further fluid in order to avoid inclusions of the first fluid and to ensure complete filling, in particular of predetermined subregions, with the second fluid.

According to a further embodiment, the method may additionally comprise a step of evaluating a reaction of the sample liquid on the processing unit after a portion of the sample liquid introduced into the receiving chamber has been discharged from the receiving chamber. For example, the fluid following the sample liquid may be transparent so that optical reactions of the sample liquid remaining in the processing unit can, in particular, be clearly seen.

In addition, a method for producing a variant of the previously presented flow cell is presented, wherein the method comprises a step of providing the receiving unit and the cover unit and a step of assembling the receiving unit and the cover unit for producing a variant of the previously presented flow cell. The receiving unit and the cover unit may, for example, be formed from polymer substrate, for example polycarbonate (PC), polypropylene (PP), polyethylene (PE), cycloolefin copolymer (COP, COC), polymethyl methacrylate (PMMA) or polydimethyl siloxane (PDMS). For example, the produced components may have a thickness of 0.6 mm to 30 mm, in particular 1 mm to 10 mm.

Variants of this method can be implemented, for example, in software or hardware or in a mixed form of software and hardware, for example in a control device.

The approach presented here furthermore creates a control device which is designed to perform, control, or change, in corresponding units, the steps of a variant of a method presented here. Even this embodiment variant of the invention in the form of a control device can quickly and efficiently achieve the object underlying the invention. In particular, at least one microfluidic pumping unit may be operated by the control device to process at least one fluid.

For this purpose, the control device may comprise at least one computing unit for processing signals or data, at least one storage unit for storing signals or data, at least one interface to a sensor or an actuator for reading sensor signals from the sensor or for outputting control signals to the actuator, and/or at least one communication interface for reading or outputting data embedded in a communication protocol. For example, the computing unit may be a signal processor, a microcontroller, or the like, wherein the storage unit may be a flash memory, an EEPROM, or a magnetic storage unit. The communication interface may be designed to read or output data in a wireless and, additionally or alternatively, wired manner, wherein a communication interface capable of reading or outputting wired data may, for example, electrically or optically read said data from a corresponding data transmission line or output them into a corresponding data transmission line.

In the present case, a control device is understood to mean an electrical device that processes sensor signals and outputs control signals and/or data signals as a function thereof. The control device may comprise an interface, which may be formed by hardware and/or software. In a hardware design, the interfaces can, for example, be part of a so-called system ASIC, which contains various functions of the control device. However, it is also possible that the interfaces are separate, integrated circuits or at least partially consist of discrete structural elements. In a software design, the interfaces may be software modules that are present, for example, on a microcontroller in addition to other software modules.

A computer program product or a computer program with program code that can be stored on a machine-readable carrier or storage medium, such as a semiconductor memory, a hard disk memory, or an optical memory, and that is used for performing, implementing, and/or actuating the steps of the method according to one of the embodiments described above is advantageous as well, in particular when the program product or program is executed on a computer or a device.

Embodiment examples of the approach presented here are illustrated in the drawings and explained in more detail in the following description. Here:

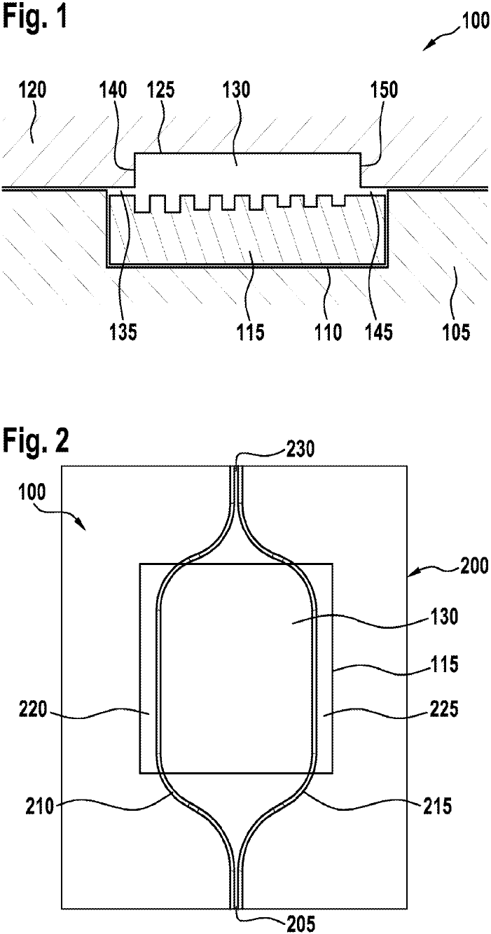

FIG. 1 shows a schematic cross-sectional view of an embodiment example of a flow cell;

FIG. 2 shows a schematic representation of an embodiment example of a flow cell;

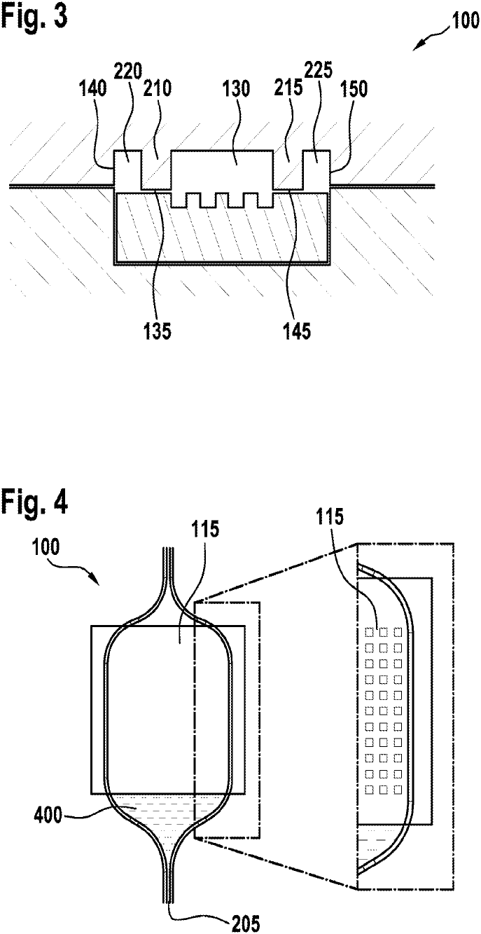

FIG. 3 shows a schematic cross-sectional view of an embodiment example of a flow cell with a capillary channel;

FIG. 4 shows a schematic representation of an embodiment example of a flow cell during the introduction of the sample liquid;

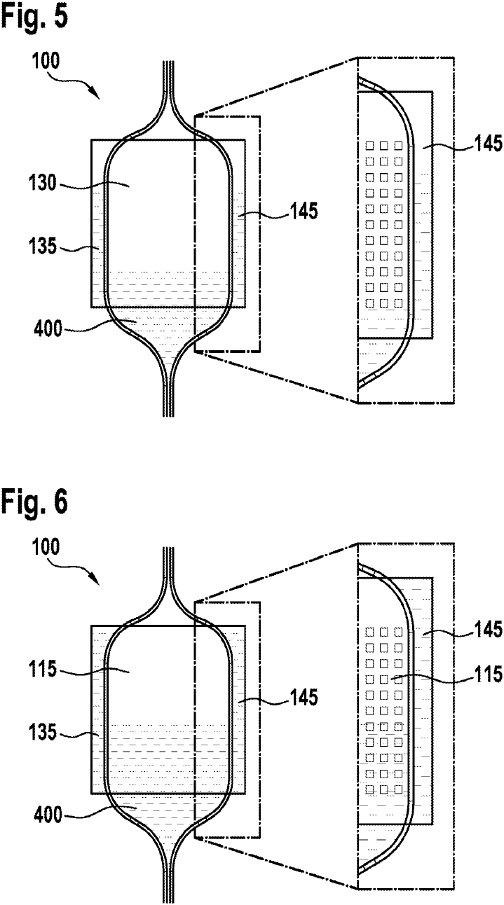

FIG. 5 shows a schematic representation of an embodiment example of a flow cell during the filling of the capillary gap and of the further capillary gap;

FIG. 6 shows a schematic representation of an embodiment example of a flow cell during the filling of the processing unit;

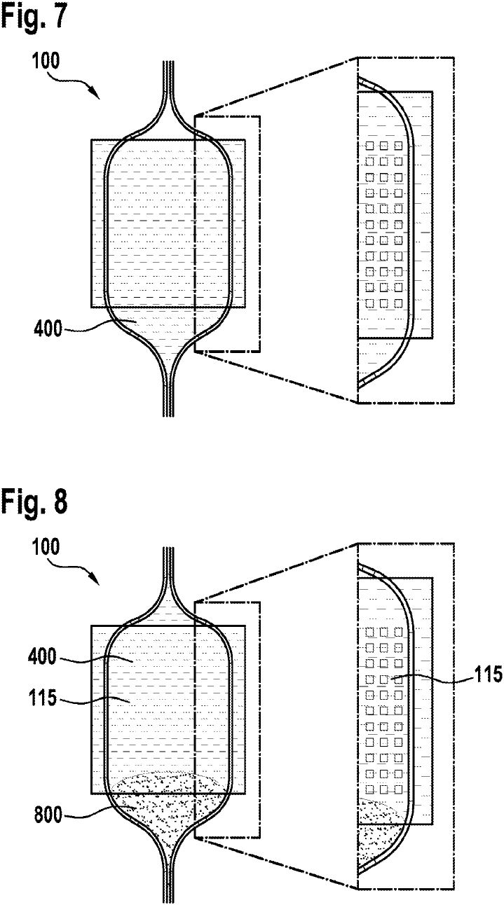

FIG. 7 shows a schematic representation of an embodiment example of a flow cell completely filled with sample liquid;

FIG. 8 shows a schematic representation of an embodiment example of a flow cell during the introduction of a sealing fluid;

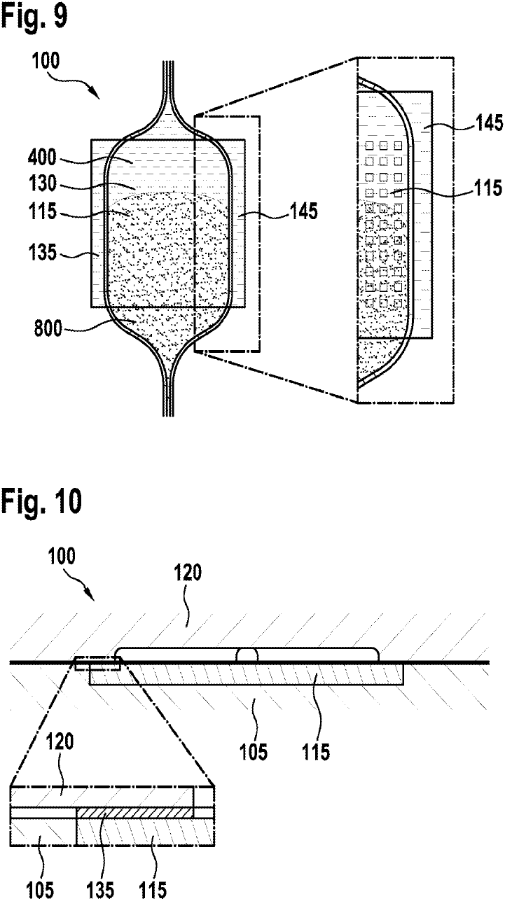

FIG. 9 shows a schematic representation of an embodiment example of a flow cell during the displacement of the sample liquid by the sealing fluid;

FIG. 10 shows a schematic cross-sectional view of an embodiment example of a flow cell with a capillary gap;

FIG. 11 shows a flow chart of an embodiment example of a method for processing a sample liquid;

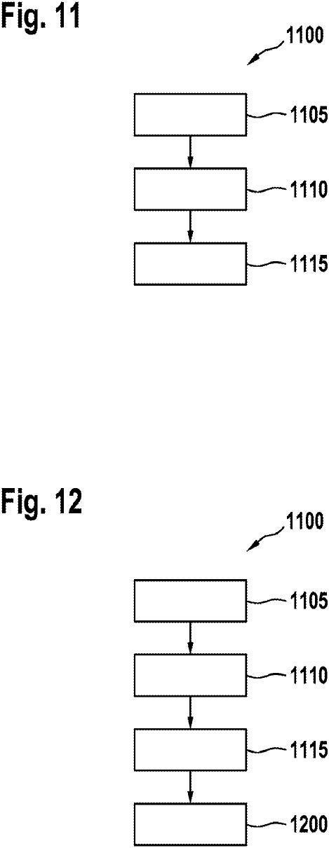

FIG. 12 shows a flow chart of an embodiment example of a method for processing a sample liquid with an additional step of displacing;

FIG. 13 shows a flow chart of an embodiment example of a method for processing a sample liquid with an additional step of evaluating; and

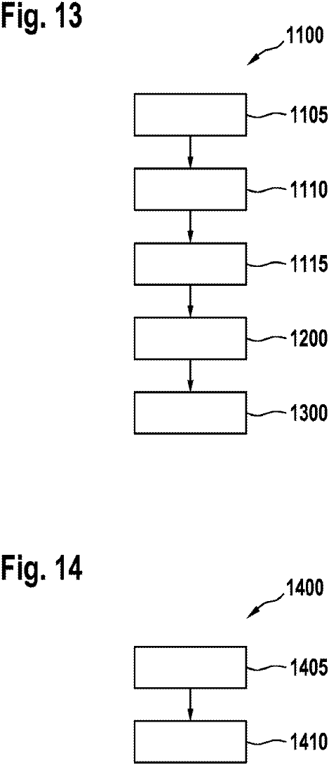

FIG. 14 shows a flow chart of an embodiment example of a method for producing a flow cell;

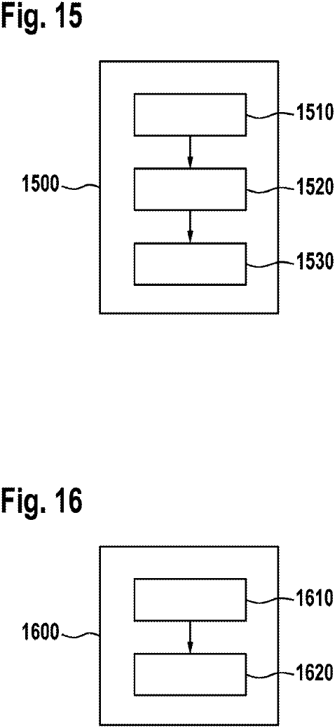

FIG. 15 shows a block diagram of an embodiment example of a control device for controlling steps of an embodiment example of a method for processing a sample liquid; and

FIG. 16 shows a block diagram of an embodiment example of a control device for controlling steps of an embodiment example of a method for producing a flow cell.

In the following description of favorable embodiment examples of the present invention, identical or similar reference numbers are used for the elements shown in the various figures and acting similarly, wherein a repeated description of these elements is dispensed with.

If an embodiment example encompasses an “and/or” conjunction between a first feature and a second feature, this is to be read such that the embodiment example according to one embodiment comprises both the first feature and the second feature and according to a further embodiment comprises either only the first feature or only the second feature.

FIG. 1 shows a schematic cross-sectional view of a flow cell 100 according to an embodiment example. The flow cell 100 comprises a receiving unit 105 with a depression 110 in which a processing unit 115 is arranged. In this embodiment example, the processing unit 115 is formed as a silicon microcavity array for aliquoting a sample liquid. Arranged over the receiving unit 105 and thus also over the processing unit 115 is a cover unit 120, which may also contain fluidic structures of the microfluidic system and which is also formed with a recess 125, wherein a receiving chamber 130 is formed between the recess 125 and the depression 110. The receiving chamber 130 is designed to receive a fluid, wherein the processing unit 115 as well as other regions of the receiving chamber 130 are wetted with the fluid. The fluid also penetrates into the capillary gap 135 formed between an edge region 140 of the cover unit 120 and the processing unit 115. In another embodiment example, the capillary gap is formed at a lateral offset between the cover unit 120 and the receiving unit 105. In this embodiment example, a further capillary gap 145, which is formed between a further edge region 150 of the cover unit 120 and the receiving unit 105, is arranged opposite the capillary gap 135.

In the flow cell 100 shown here, so-called priming of the structures can be performed, wherein regions of the receiving chamber 130 are pre-wet by a sample liquid, which may also be referred to as the fluid to be processed, or by an additional fluid. In another embodiment example, a gas, for example CO2, or a further fluid, for example ethanol, may also be used for this purpose. In this embodiment example, the flow cell 100, into which the processing unit 115, which may also be referred to as an additional component, is integrated, is designed in terms of fluidics such that the processing unit 115 can be integrated and processed so that priming-free, sequential fluidic processing of the processing unit 115 is enabled. The flow cell 100 is designed such that by the integration of the processing unit 115 and by the joining of the receiving unit 105 to the cover unit 120, a capillary gap 135, which may also be referred to as a gap, is created that can be filled in a capillary manner, whereby a capillary guide is created. Here, the capillary gap 135 arranged between the processing unit 115 and the cover unit 120 is significantly smaller than a central region of the receiving chamber 130, which may also be referred to as the head space of the flow cell 100. The capillary gap height is thus less than the height between the functional portion of the processing unit 115, which is to be filled, and the cover unit 120 of the flow cell 100.

FIG. 2 shows a schematic representation of a flow cell 100 according to an embodiment example. This may be the flow cell described in FIG. 1.

In this embodiment example, the flow cell 100 is arranged in a microfluidic device 200 and is designed to receive fluid through an inlet opening 205. From the inlet opening 205, an elevation 210 and a further elevation 215 respectively extend along two opposite sides of the processing unit 115, wherein they delimit a capillary channel 220 and a further capillary channel 225 from a region of the receiving chamber 130. In this embodiment example, the flow cell 100 is designed to draw the fluid through a capillary gap, as described in FIG. 1, between the processing unit 115 and the elevation 210 into the capillary channel 220 as well as between the processing unit 115 and the further elevation 215 into the further capillary channel 225. In this way, the receiving chamber 130 is wetted by the fluid, whereby inhomogeneities in the material of the flow cell 100 are compensated. As a result, enclosure of the fluid in the capillary gaps as well as the capillary channel 220 and the further capillary channel 225 is achieved so that a subsequent filling of the receiving chamber with a sample liquid is possible. On a side of the flow cell 100 opposite the inlet opening 205, the elevation 210 and the further elevation 215 extend toward an outlet opening 230 for dispensing the previously received fluid or a portion of the previously received fluid.

FIG. 3 shows a schematic cross-sectional view of an embodiment example of a flow cell 100 with a capillary channel 220. The flow cell may be the flow cell described in the previous figures. In this embodiment example, the receiving chamber 130 is delimited on both sides by the elevation 210 and the further elevation 215 so that the actual receiving chamber 130 is shown to be smaller than the receiving chamber described in FIG. 1. A capillary channel 220 is formed between the elevation 210 and the edge region 140, and a further capillary channel 225 is formed in the same manner between the further elevation 215 and the further edge region 150. The capillary channel 220 as well as the further capillary channel 225 are designed in this embodiment example to receive fluids introduced into the receiving chamber 130. For this purpose, an introduced fluid, which may be, by way of example only, the sample liquid, is drawn by capillary forces through the capillary gap 135 into the capillary channel 220 and through the capillary gap 145 into the capillary channel 225. Fluid enclosed in the capillary gap 135 and in the further capillary gap 145 seals the receiving chamber 130 to both sides and prevents undesirable pinning of fluids subsequently introduced into the receiving chamber 130.

FIG. 4 shows a schematic representation of an embodiment example of a flow cell 100 during the introduction of the sample liquid 400. The flow cell may be the flow cell described in the previous figures. FIG. 4 shown here is divided into a left partial figure and a right partial figure, wherein the right partial figure shows an enlargement of a portion of the schematic representation of the left partial figure. In this embodiment example, the flow cell 100 comprises a processing unit 115, which may also be referred to as an aliquoting structure and is formed with a silicon microcavity array, by way of example only. In the illustration shown here, the sample liquid 400 is introduced into the flow cell 100 through the inlet opening 205.

FIG. 5 shows a schematic representation of an embodiment example of a flow cell 100 during filling of the capillary gap 135 and of the further capillary gap 145. The flow cell may be the flow cell described in the previous figures, and the sample liquid may be the sample liquid described in FIG. 4. Similarly to FIG. 4, FIG. 5 shown here is also divided into two partial figures, wherein the right partial figure shows an enlargement of a portion of the schematic representation of the left partial figure. In the representation shown here, the sample liquid 400 reaches the capillary gap 135 and the further capillary gap 145, which each may also be referred to as capillary guides. Due to capillary forces, the sample liquid 400 is drawn into the capillary gap 135 and the further capillary gap 145 and fills them even before the receiving chamber 130 is completely filled.

FIG. 6 shows a schematic representation of an embodiment example of a flow cell 100 during filling of the processing unit 115. The flow cell may be the flow cell described in the previous figures, and the processing unit may be the processing unit described in the previous figures. Similarly to FIGS. 4 and 5, FIG. 6 shown here is also divided into two partial figures, wherein the right partial figure shows an enlargement of a portion of the schematic representation of the left partial figure. In the representation shown here, the capillary gap 135 and the further capillary gap 145 are completely filled with the sample liquid 400, and the sample liquid 400 passes onto the processing unit 115 and fills the compartments to be aliquoted.

FIG. 7 shows a schematic representation of an embodiment example of a flow cell 100 completely filled with sample liquid 400. The flow cell may be the flow cell described in the previous figures. Similarly to FIGS. 4, 5 and 6, FIG. 7 shown here is also divided into two partial figures, wherein the right partial figure shows an enlargement of a portion of the schematic representation of the left partial figure. In the illustration shown here, the entire flow cell 100 is wetted with the sample liquid 400.

FIG. 8 shows a schematic representation of an embodiment example of a flow cell 100 during the introduction of a sealing fluid 800. The flow cell may be the flow cell described in the previous figures. Similarly to FIGS. 4, 5, 6 and 7, FIG. 8 shown here is also divided into two partial figures, wherein the right partial figure shows an enlargement of a portion of the schematic representation of the left partial figure. In the representation shown here, in order to displace the sample liquid 400, which may also be referred to as fluid 1, and to seal the processing unit 115, a sealing fluid 800, which may also be referred to as fluid 2 or as displacement fluid, is introduced into the flow cell 100. In this embodiment example, the sealing fluid is a mineral oil. Optionally, silicone oils, fluorinated hydrocarbons, such as 3M Fluorinert or Fomblin, may also be used in a suitable combination, wherein the two phases are non-miscible or only slightly miscible, for example 3M Fluorinert FC40, FC-70 and/or silicone oil.

FIG. 9 shows a schematic representation of an embodiment example of a flow cell 100 during the displacement of the sample liquid 400 by the sealing fluid 800. The flow cell may be the flow cell described in the previous figures. Similarly to FIGS. 4, 5, 6, 7 and 8, FIG. 9 shown here is also divided into two partial figures, wherein the right partial figure shows an enlargement of a portion of the schematic representation of the left partial figure. In the representation shown here, the receiving chamber 130 is largely filled with the sealing fluid 800, whereby the sample liquid 400 is being displaced from the receiving chamber 130. The sample liquid 400 enclosed in the capillary gap 135 and in the further capillary gap 145 remains there and, in the sequential process management of the aliquoting structure with the sealing fluid 800, serves as phase shaper of the resulting interface between the sample liquid 400 and the sealing fluid 800. As a result, a complete pinning-free displacement of the sample liquid 400 from the functional region of the processing unit 115 with the compartments to be aliquoted is achieved.

FIG. 10 shows a schematic cross-sectional view of an embodiment example of a flow cell 100 with a capillary channel 135. The flow cell may be the flow cell described in the previous figures. In order to illustrate the formation of the capillary gap 135, FIG. 10 shown here is divided into two partial figures, wherein the lower partial figure shows an enlargement of a portion of the schematic representation of the upper partial figure. In this embodiment, the capillary gap 135 is arranged between the cover unit 120, which may also be referred to as the microfluidic component top side, and the processing unit 115, which may also be referred to as the silicon component. Both the processing unit 115 and the capillary gap 135 are surrounded by the receiving unit 105, which may also be referred to as the microfluidic component bottom side. In an alternative embodiment example, the capillary gap 135 may also be placed laterally of the processing unit 115, which may also be referred to as the component to be integrated, and/or only in subregions of the flow cell 100.

In other words, the preceding FIGS. 1 to 10 show a flow cell 100, which permits continuous pinning-free wetting of subregions of the flow cell 100 with a sample liquid 400 by using a further liquid or a sealing fluid 800 and by utilizing a retention or enclosure, induced by capillary forces, of the further liquid on a dedicated surface or in dedicated subregions of the flow cell 100. The flow cell 100 is thus designed such that retention or enclosure of the further liquid takes place in subregions, in particular dedicated subregions, such as capillary gaps, in order to achieve a particularly defined filling of other subregions of the flow cell 100 with a sample liquid 400.

FIG. 11 shows a flow chart of an embodiment example of a method 1100 for processing a sample liquid with a flow cell. The flow cell may be the flow cell described in the previous figures. The method 1100 comprises a step 1105 of wetting the at least one capillary gap with the fluid. In other words, in this first step, subregions of the flow cell are wetted with a liquid. In addition, the method 1100 comprises a step 1110 of enclosing a portion of the fluid in the capillary gap and a step 1115 of introducing a sample liquid into the receiving chamber. Step 1110 of enclosing and step 1115 of introducing may also be performed in reverse order or simultaneously. In other words, the sample liquid is introduced into the flow cell. In particular, when the sample liquid is introduced, retention or enclosure, induced by capillary forces, of the fluid on a surface or in subregions of the flow cell takes place so that a continuous pinning-free filling of subregions of the flow cell with the sample liquid can be achieved, that is, in particular, a filling in which a continuous progression of a phase interface, adjacent to the sample liquid, through the flow cell is achieved. By using the fluid and pre-wetting a surface of the flow cell with the fluid and by enclosing the fluid in subregions of the flow cell, the wetting behavior of the sample liquid can advantageously be adjusted during the filling of subregions of the flow cell.

FIG. 12 shows a flow chart of an embodiment example of a method 1100 for processing a sample liquid with a flow cell, comprising an additional step 1200 of displacing at least a portion of the fluid by the sample liquid. In another embodiment example, step 1200 of displacing a portion of the fluid may be performed by a further fluid. In this embodiment example, sequential processing with several fluids in the flow cell is enabled. This is in particular desired if it is necessary for the analysis of a sample to completely fill and re-empty a microfluidic structure at least in subregions or to completely displace a fluid from the structure.

FIG. 13 shows a flow chart of an embodiment example of a method 1100 for processing a sample liquid with a flow cell, comprising an additional step 1300 of evaluating. In the step 1300 of evaluating, a reaction of the sample liquid is evaluated on the processing unit after a portion of the sample liquid introduced into the receiving chamber has been discharged from the receiving chamber.

FIG. 14 shows a flow chart of an embodiment example of a method 1400 for producing a flow cell. The method 1400 comprises a step 1405 of providing the receiving unit and the cover unit and a step 1410 of assembling the receiving unit and the cover unit.

FIG. 15 shows a block diagram of an embodiment example of a control device 1500 for controlling steps of an embodiment example of a method 1100 for processing a sample liquid. The control device 1500 comprises a unit 1510 for wetting the at least one capillary gap with the fluid. In addition, the control device 1500 comprises a unit 1520 for enclosing a portion of the fluid in the capillary gap and a unit 1530 for introducing a sample liquid into the receiving chamber.

FIG. 16 shows a block diagram of an embodiment example of a control device 1600 for controlling steps of an embodiment example of a method 1400 for producing a flow cell. The control device 1600 comprises a unit 1610 for providing the receiving unit and the cover unit and a unit 1620 for assembling the receiving unit and the cover unit.

1. A flow cell for integrating a processing unit into a microfluidic device, the flow cell comprising:
a receiving unit with a depression configured to receive the processing unit ;
a cover unit configured to cover the depression ; and
at least one capillary gap configured to receive a fluid,
wherein the capillary gap is formed between an edge region of the cover unit and the receiving unit and/or between the cover unit and the processing unit .

2. The flow cell according to claim 1, wherein:
the cover unit comprises a recess, and
a receiving chamber for receiving the fluid is or can be formed between the processing unit arranged or arrangeable in the depression and the recess.

3. The flow cell according to claim 2, wherein a capillary gap height is less than a height of a central region of the receiving chamber .

4. The flow cell according to claim 1, further comprising:
a further capillary gap arranged at a further edge region of the cover unit opposite the capillary gap.

5. The flow cell according to claim 1, wherein:
the cover unit comprises an elevation along the edge region,
a capillary channel is formed between the elevation and the edge region, and
the capillary gap is defined between the elevation and the processing unit.

6. The flow cell according to claim 4, further comprising:
an inlet opening for introducing the fluid in a direction of flow into the receiving chamber,
wherein the receiving chamber is laterally delimited in the direction of flow by the capillary gap and the further capillary gap.

7. The flow cell according to claim 1, wherein the capillary gap is adjacent to the depression.

8. A method for processing a sample liquid with a flow cell that has a receiving unit with a depression configured to receive a processing unit, a cover unit configured to cover the depression, and at least one capillary gap for receiving a fluid, the capillary gap being formed between an edge region of the cover unit and the receiving unit and/or between the cover unit and the processing unit, the method comprising:
wetting the at least one capillary gap with the fluid;
enclosing a portion of the fluid in the capillary gap ; and
introducing a sample liquid into the receiving chamber .

9. The method according to claim 8, wherein the sample liquid is used as the fluid in the wetting of the at least one capillary gap and the, enclosing of the portion of the fluid .

10. The method according to claim 8, further comprising:
displacing at least a portion of the fluid by the sample liquid and/or by a further fluid.

11. The method according to claim 8, further comprising:
evaluating a reaction of the sample liquid on the processing unit after a portion of the sample liquid introduced into the receiving chamber has been discharged from the receiving chamber.

12. A method for producing a flow cell, the method the method comprising:
assembling a receiving unit, which has a depression configured to receive a processing unit, and a cover unit so as to cover the depression in such a way that at least one capillary gap, which is configured to receive a fluid, is formed between an edge region of the cover unit and the receiving unit and/or between the cover unit and the processing unit.

13. A control device configured to carry out and/or control the steps of the method according to claim 8.

14. A computer program configured to carry out and/or control the steps of the method according to claim 8.

15. A machine-readable storage medium on which the computer program according to claim 14 is stored.

16. The flow cell according to claim 3, wherein the capillary gap height is no more than 10% of the height of the central region of the receiving chamber.
